(19) United States
(12) Patent Application Publication
(10) Pub. No.: US 2012/0132780 A1
(43) Pub. Date: May 31, 2012

(54) BASE FOR A TRANSPORTABLE MAST AND A MAST ASSEMBLY COMPRISING SUCH A BASE

(75) Inventor: Edmond Oyen, Zutendaal (BE)

(73) Assignee: SECOBEL, Genk (BE)

(21) Appl. No.: 13/320,132

(22) PCT Filed: May 11, 2009
(86) PCT No.: PCT/EP09/55683

§ 371 Date: Jan. 24, 2012

(51) Int. Cl. H01Q 1/12; F16M 11/02

(52) U.S. Cl. 248/523

(57) ABSTRACT

The invention relates to a base for a transportable mast comprising a plurality of superimposed tubular mast elements, the base comprising a guide shaft with an opening for guiding the displacement of the tubular mast elements, legs connected to the guide shaft, for positioning the guide shaft at a distance above ground. The invention also relates to a mast assembly comprising the base, and a field base for limiting movement of the mast, and a guy control assembly for keeping the mast upright during erection or retraction of the mast.

### FIELD OF THE INVENTION

The invention relates to a base for a transportable mast comprising a plurality of tubular mast elements positioned on top of each other, the base comprising a guide shaft with an opening for guiding the displacement of the tubular mast elements during erection or retraction of the mast; a plurality of legs connected to the guide shaft, for positioning the guide shaft at a distance above ground, according to the preamble of the first claim.

### BACKGROUND OF THE INVENTION

Such transportable masts are for example used for supporting and orienting temporary transmitting and/or receiving antennas, for both military and civilian purposes, at a distance above the ground of e.g. 2 to 25 meters.

Transportable masts of this kind are usually constructed using a tripod with a circular upright opening, in which a first tubular element is inserted in an upright position. An antenna is attached to the top of this first tubular element. Then the first tubular element is lifted together with the antenna, so that a second tubular element can be inserted underneath the first tubular element. The top of the second tubular element engages the bottom of the first tubular element, and so on.

### Prior Art Description

GB1180776 describes a telescopic mast to support antennas or lighting fittings, comprising a plurality of concentric telescopic tubes. In folded condition of the mast the tubes are positioned one inside the other. Each telescopic tube is provided with a plurality of flanges distributed on the periphery thereof, and cooperating through friction reducing material to guide the displacement of telescopic mast tubes when erecting the mast. The space between the flanges can be used for accommodating cables. The mast known from GB1180776 has the disadvantages that it cannot be rotated, and that its construction is complicated and expensive.

FR449789 published in 1913 describes a transportable mast composed of a plurality of superimposed tubular elements which form the mast. The mast is supported by a base to which a winch is mounted to lift the tubular elements. When erecting the mast, additional tubular elements are added to the mast from below the already present tubular elements. The base basically consists of a first and a second ring, which are spaced apart in height direction. The legs are hingedly connected to the rings. Each ring comprises a central opening through which the mast tubular elements are shifted and lifted. The mast known from FR449789 however has the disadvantage that the first and second rings are not connected, as a result of which they can tilt thus obstructing easy sliding of the tubular elements during erection of the mast.

NL6917045 published in 1970 describes a transportable mast for erecting antennas, using a supporting structure with a top flange, the supporting structure being made of a rigid block to which a plurality of legs are connected in a non-pivotable manner over the entire height of the block. The supporting structure is provided to permit advancing mast sections from a position below the supporting structure through an opening below the flange. NL6917045 however has the disadvantage that the supporting structure is usually made of a single casted block, made as a unity piece, which is heavy and difficult to manufacture.

### DESCRIPTION OF THE INVENTION

It is an aim of the present invention to provide a base for a transportable mast, which permits mounting mast sections from a position below the base, which is lightweight and easy to manufacture.

This aim is achieved according to the present invention with a base showing the technical features of the characterizing part of the first claim.

Thereto, the base of the present invention is characterized in that the guide shaft comprises a tubular pipe having the opening for guiding the displacement of the tubular mast elements; a first leg attachment collar mounted to an upper part of the tubular pipe, the first leg attachment collar being connectible to the legs at a first connection position on the legs, the tubular pipe extends from the first leg attachment collar to a position below the first leg attachment collar to permit mounting of second connection means to the legs; second connection means mounted to a lower part of the tubular pipe, which second connection means are connectible to the legs at a second connection position on the legs, the second connection position being spaced from the first connection position in height direction of the base, wherein the tubular pipe is made of a first material and the first leg attachment collar is made of a second material.

Instead of using one heavy and bulky element as the guide shaft to which the legs are connected and which is usually made of cast iron as one single piece, the inventor now provides a guide shaft which comprises at least two parts. By dividing the guide shaft in parts, the material and shape of each part can be optimized according to the function it has to fulfill. This way the material of the first leg attachment collar can be selected primarily to provide a strong and stable base that is capable of temporarily bearing the full weight of the mast during its erection or retraction, and transferring it to the legs. And the material of the tubular pipe can be selected to guarantee easy sliding of the mast elements therein. The tubular pipe will therefore usually be made of a lightweight material with a smooth inner surface. By connecting the legs of the base at both an upper and a lower position of the tubular pipe, stability of the base and the mast is optimised.

Due to the presence of a tubular pipe between the insertion position and mounting position of the mast elements, the displacement of the mast elements is guided when erecting or retracting the mast, thereby supplying the mast elements in the proper direction, and preventing the mast elements from tilting, which would obstruct easy setup of the mast. Because the tubular pipe extends from the first to the second connection position on the tubular pipe, deviations from the path that the mast elements need to follow during erection of the mast is counter-acted.

As the legs are connectible to the base at two distinct connection positions on the legs, which are spaced apart in height direction of the base, the legs can provide for a base with a stable structure.

The tubular pipe also facilitates optimal alignment of the tubular mast elements on top of each other.

Preferably, the second connection means comprises a leg guide collar, which extends around the lower part of the tubular pipe, which is spaced apart from the first leg attachment collar in height direction of the base, is movable in a direction along a longitudinal axis of the tubular pipe, and is connected to the legs via guide spacers to permit movement of the legs of the base between an extended position in which they stably support the base and a retracted position for easy transportation. In this way the leg guide collar provides a second connection between the tubular pipe and the legs, which is spaced at a distance from the first connection and in that way enhances the stability and rigidity of the base. By connecting the legs to a collar around the tubular pipe any forces exerted to the collar can be distributed over a large contact area. The movable mounting of the leg guide collar provides a foldable base in which all the legs can be extended or retracted simultaneously. This allows a very easy and quick set-up of the base, even by only one person. By providing a tubular pipe with a first leg attachment collar mounted to a top portion and a leg guide collar mounted to a lower portion, both of which are attached to the legs, the position of the tubular pipe is automatically vertical when the base is unfolded on a horizontal surface, thus again saving set-up time, which is a crucial parameter for military missions, but also for radio/television/film recordings.

The leg guide collar is preferably made of a third material, which may be the same as or different from the first or second material. The material of the leg guide collar can be chosen primarily for easy sliding of the leg guide collar over the tubular pipe.

In a preferred embodiment of the present invention the first, second and third material have a mass density between 1.0 and 3.0 kg/dm³. Using materials with a low mass density provides a lightweight guide shaft, which is easy to produce. A base comprising this guide shaft is easy to transport and can be easily set-up by only one person.

In a preferred embodiment of the present invention the first, second and third material are chosen from the group of aluminum, an alloy of aluminum with another metal, a plastic material selected from the group of polyoxymethyleen (POM), PTFE (Teflon), polyurethane (PUR), polyamide particularly nylon 6, nylon 66, nylon 11, nylon 12 or nylon 46 or copolymers thereof, polyester, in particular polyethylene-terephtalate (PET), polytrimethyleneterephtalate (PTT), polybutyleneterephtalate (PBT), high molecular weight polyethylene, ultra high molecular weight polyetheylene, polyetherketones, particularly polyethyletherketone (PEEK), PEEKK, polyethersulfones, polysylfones, polyvinylidenefluoride (PVDF), a polyester copolymer or mixtures of two or more of these polymers. By use of these materials, a base that is strong and lightweight can be provided.

In a preferred embodiment of the present invention the first material is a plastic material, preferably POM, and the second and third material are aluminum or an aluminum alloy. By using these materials, the dynamic friction between the tubular pipe and the tubular mast elements which are usually made of aluminum can be minimized when the mast elements are moved through the pipe upon erection or retraction of the mast, as well as the dynamic friction between the tubular pipe and the first leg attachment collar during production, and the dynamic friction between the tubular pipe and the leg guide collar when folding or unfolding the base, thereby reducing the effort and the wear during the set-up and retraction of the base for the mast, as well as the time required to set-up or retract the mast. The use of these materials permits reducing the weight of the guide shaft and the base, and a strong and stable base, which can easily be produced, is provided. Further, by providing the entire tubular pipe of a low friction material, the use of friction limiting strips or wheels inside the guide shaft can be dispensed with, saving cost and labor during manufacturing, and obstruction of the mast elements by loosening strips or broken wheels is prevented, and wearing of the friction reducing material occurs in a more uniform way over the entire inner surface of the tubular pipe.

In a preferred embodiment of the present invention the tubular pipe has a circular cross section with a substantially constant outer diameter over at least part of its height in axial direction, to allow movement of the leg guide collar along an outer wall of the tubular pipe. The tubular pipe comprises first position limiting means on the upper part of the tubular pipe to limit movement of the first leg attachment collar along the tubular pipe in upward direction.

In a preferred embodiment of the present invention the tubular pipe comprises second position limiting means on the lower part of the tubular pipe to limit movement of the leg guide collar in downward direction, the second position limiting means being spaced apart from the first position limiting means to permit movement of the leg guide collar between them during normal use. The second position limiting means prevent the leg guide collar from leaving the tubular pipe during normal use, after production of the base.

The present invention also relates to a mast assembly comprising a base as described above and a mast.

In a preferred embodiment of the present invention the mast assembly additionally comprises at least one guy control assembly for stabilizing the mast during erection or retraction of the mast, the guy control assembly being connected to the mast at a predefined position T in at least three directions by means of at least three guy control wires, a first end of each guy control wire being connected to the mast, a second end of each guy control wire being connected to the guy control assembly, each guy control wire being guided at a position between the first and second end of the guy control wire towards a ground position located at a distance R from the base, to which positions they can be fastened or from which positions they can be routed further to a single position P to permit keeping the guy control wires under tension by a single person. The guy control assembly of the present invention, and the way of fastening it to the mast assembly allows to keep the mast upright from the start to the end of the mast erection or retraction, with only one person holding the guy control assembly. It prevents the mast from falling over, thereby causing injuries or material damage to the mast or to the equipment mounted to the mast, or to the objects where the mast could fall upon.

The mast assembly further preferably comprises a field base for supporting the mast, which field base is provided for positioning on the ground or any other suitable support at a position which corresponds to the position of the mast to permit bearing of at least part of the weight of the mast after erection, whereby the field base comprises first fixation means for fixing the mast to a support plane and preventing displacement in height direction of the mast assembly, and second fixation means for preventing rotation of the mast around its axial axis. The field base can be put in place before or after all tubular elements of the mast have been mounted. After all mast elements are mounted, the height position of the mast can be lowered to a safe and stable position on the field base. In this position the weight of the mast is no longer transferred to the legs of the base, but to the field base. The first fixation means counteracts upright movement of the mast e.g. due to heavy wind, and the second fixation means assists in maintaining the orientation of the mast and the equipment mounted thereon. This is particularly important for antenna masts, where a slight deviation of the orientation of the antenna has large impact on the quality of the connection, and can even lead to loss of communication. By providing second fixation means which provide a releasable connection, the orientation of the mast can easily be adapted by rotating the mast without having to lift the mast or to remove the mounting of the field base to the ground. It also makes the use of other means for fixing the orientation of the mast with respect to the base superfluous, as this could scratch or damage the outer surface of the antenna mast elements, and the inner surface of the guide shaft.

### LIST OF THE FIGURES

The invention is further elucidated in the appending figures and figure description. Note that the figures are not drawn to the scale. The figures are intended to describe the principles of the invention.

FIG. 1A shows a view to the preferred embodiment of the base for a transportable mast according to the present invention.

FIG. 1B shows a close-up view to the guide shaft of the base of FIG. 1A.

FIG. 1C shows an example of a hinge pin with two circlipses.

FIG. 2A shows the base of FIG. 1A in an extended position, whereby the legs are maximally unfolded.

FIG. 2B shows the base of FIG. 2A, whereby the legs are partly folded, partly unfolded.

FIG. 2C shows the base of FIG. 2A in a retracted position, whereby the legs are maximally folded.

FIG. 2D shows an alternative embodiment of the base of the present invention.

FIG. 2E shows a cross section of the base of FIG. 2F in plane A-A.

FIG. 2F shows a base with a graduated collar.

FIG. 3A shows a preferred embodiment of the tubular pipe according to the present invention.

FIG. 3B shows a preferred embodiment of the first leg attachment collar according to the present invention.

FIG. 3C shows a preferred embodiment of the leg guide collar according to the present invention.

FIG. 3D shows a preferred embodiment of the first circlips according to the present invention.

FIG. 3E shows a preferred embodiment of the second circlips according to the present invention.

FIG. 4A shows the tubular pipe of FIG. 3A in side view.

FIG. 4B shows the tubular pipe of FIG. 4A over which a first leg attachment collar is shifted until it touches the tubular pipe collar.

FIG. 4C shows the tubular pipe of FIG. 4B after mounting of the first circlips.

FIG. 4D shows the tubular pipe of FIG. 4C over which a leg guide collar is shifted.

FIG. 4E shows the tubular pipe of FIG. 4D after mounting of the second circlips.

FIG. 4F shows an alternative embodiment of the tubular pipe according to the present invention.

FIG. 5A shows a partly erected antenna mast according to the present invention.

FIG. 5B shows a guy collar assembly.

FIG. 5C shows a lifting block assembly

FIG. 5D shows an example of how a guy control wire is mounted to the guy collar assembly.

FIG. 6A shows an example of a tubular mast element.

FIG. 6B shows the upper and lower part of the tubular mast element of FIG. 6A.

FIG. 6C shows another example of a tubular mast element.

FIG. 7A shows a perspective view on an antenna mast according to the present invention, whereby the antenna mast is fully erected.

FIG. 7B shows a close-up view of the connections to a picket.

FIG. 7C shows a close-up view of the connections to the control picket.

FIG. 7D shows a close-up view of a preferred embodiment of the guy control assembly according to the present invention.

FIG. 8A shows a detailed view of the guy control assembly of FIG. 7D.

FIG. 8B shows a close-up view of an example of a guy control wire.

FIG. 9A shows a perspective view on a field base according to the present invention.

FIG. 9B shows a cross section of the field base of FIG. 9C in plane B-B.

FIG. 9C shows a top view of the field base of the present invention.

FIG. 9D shows an example of how a bottom element can be fixed in a field base according to the present invention, using a first and a second fixation means which are different from each other.

FIG. 9E shows an example of how a bottom element can be fixed in a field base according to the present invention, using a first and a second fixation means which are the same.

### DESCRIPTION OF THE FIGURES

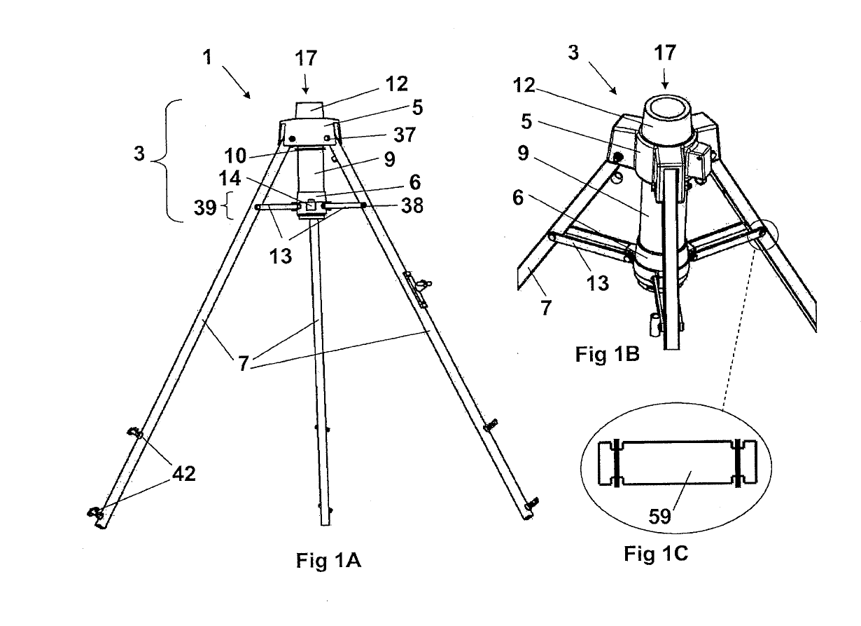

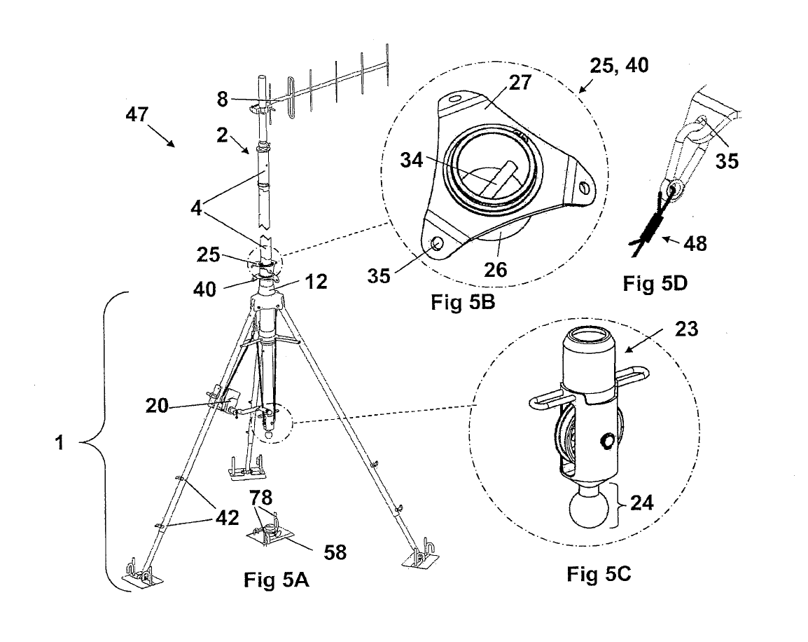

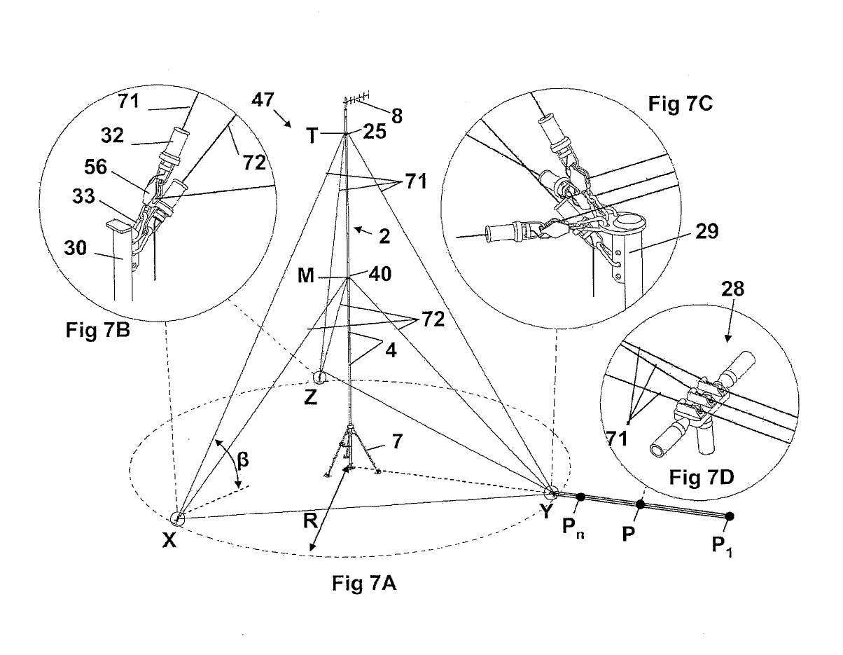

FIG. 1A shows a preferred embodiment of a base 1 for a transportable mast (not shown) according to the present invention. The base 1 is suited to support masts of e.g. 2-15 m, 2-25 m, or any other height. The mast 2 can be a sectional mast. The mast 2 usually comprises a plurality of superimposed tubular mast elements 4 of a constant outer diameter D, on top of which equipment 8 can be mounted that needs to be positioned at a predetermined height and optionally also directed in a predetermined orientation, such as e.g. an antenna, a camera, a microphone, or lighting. The rest of the description will usually describe an antenna mast, but the invention is not limited thereto. An example of such an antenna mast 2 using the base 1 of the present invention is shown in FIG. 5A and FIG. 7A, which will be described later.

FIG. 1B shows the preferred embodiment of the base of the present invention of FIG. 1A in more detail. The base 1 comprises a guide shaft 3 which comprises several parts: a tubular pipe 9, a first leg attachment collar 5 mounted to an upper part of the tubular pipe 9, and a plurality of legs 7 for supporting the mast on a positioning surface e.g. the ground, connected to the tubular pipe. With “mounted to” is meant that the first leg attachment collar 5 can e.g. be mounted on top of, against or around the tubular pipe 9. Preferably the base 1 also comprises a leg guide collar 6 to provide a second connection between the tubular pipe 9 and the legs 7.

The tubular pipe 9 is made of a first material, the first leg attachment collar 5 of a second material, and the leg guide collar 6 of a third material, wereby these materials can all be different, or all be the same, or some of them can be the same. For example, the collars 5 and 6 could be made of the same material while the tubular pipe 9 is made of a different material, or the tubular pipe 9 and the first leg attachment collar 5 could be made of the same material, while the leg guide collar 6 is made of a different material, or the tubular pipe 9 and the leg guide collar 6 could be made of the same material while the first leg attachment collar 5 is made of a different material.

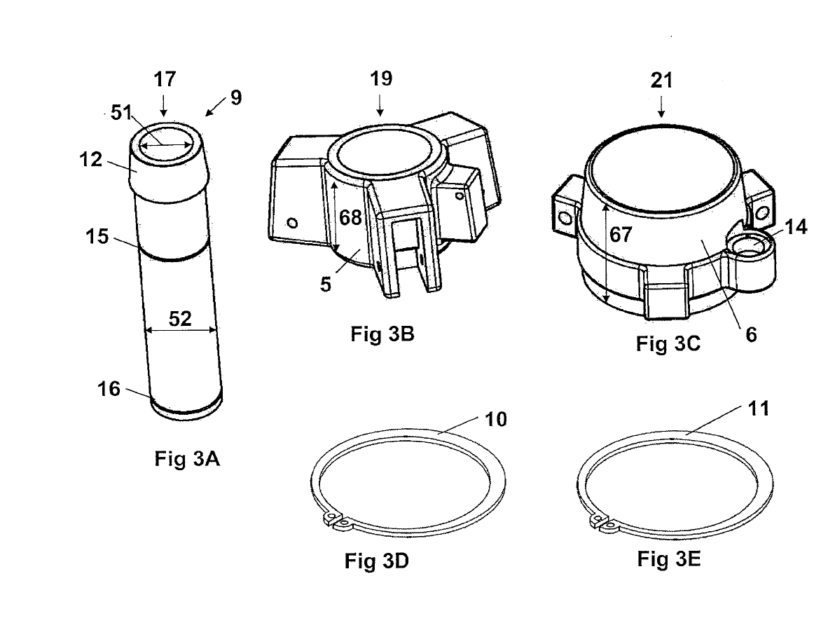

The guide shaft 3 of the present invention comprises a tubular hollow pipe 9 with an opening 17 extending from the top to the bottom of the tubular pipe for guiding the displacement of the tubular mast elements 4 during erection or retraction of the mast 2, and for holding at least one tubular mast element 4 when the mast is erected. The tubular pipe 9 of the present invention preferably has a circular cross section of a substantially constant outer diameter 52 (FIG. 3A) over the lower part of the tubular pipe 9, to allow mounting of the first leg attachment collar 5 and the leg guide collar 6 during manufacturing of the guide shaft 3. With a “substantially constant outer diameter” is meant that small deviations due to production tolerances are permitted, but it also means that one or more narrow grooves are permitted.

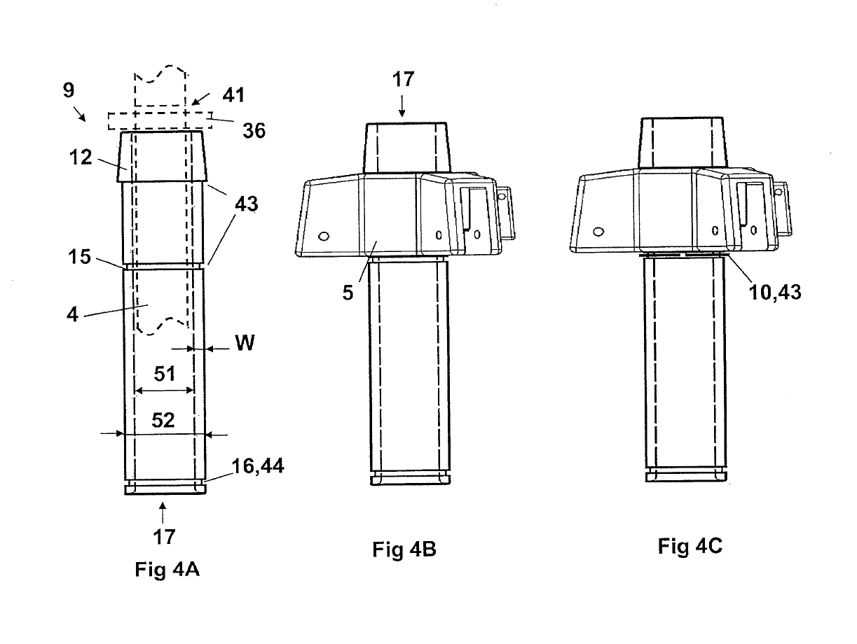

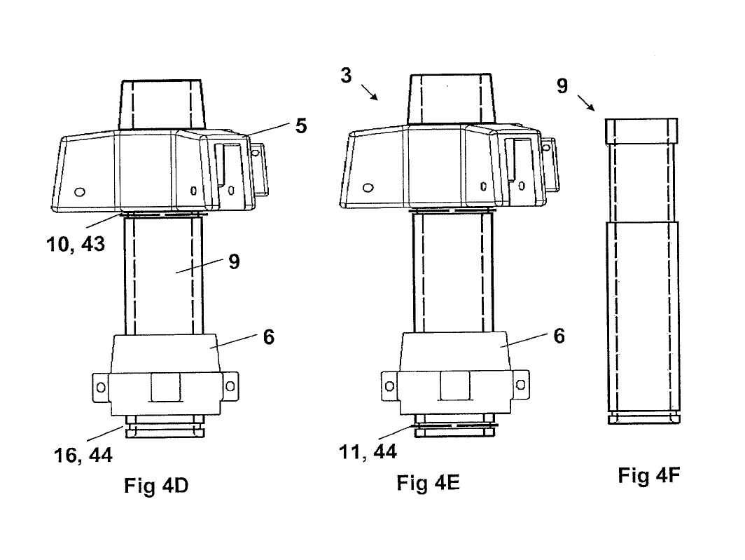

The tubular pipe 9 has an opening 17 of a constant inner diameter 51 (FIG. 3A) to allow insertion and displacement of the tubular mast elements 4 throughout the pipe during erection or retraction of the mast 2. As shown in FIG. 4A, the tubular pipe 9 has a collar 12 upon which a mast suspending pin 36, which can be inserted in transverse direction of the mast, can rest when erecting or retracting a mast, for suspending part of the mast. The tubular pipe 9 also has position limiting means 43, 44 to permit fixing the position of the first leg attachment collar 5 on the tubular pipe 9, and to restrict movement of the leg guide collar 6 on the tubular pipe 9, for example the lower part of the tubular pipe collar 12 and a first and second groove 15, 16 on the outside surface of the tubular pipe 9, wherein a circlips can be mounted. Other shapes of the tubular pipe 9 than the one shown in FIG. 4A are also possible, for example the shape of the tubular pipe collar 12 can be cylindrical instead of conical. The tubular pipe 9 is preferably made of POM (Polyoxymethyleen), which is a strong and lightweight material, having a mass density of only 1.4 kg/dm³. This material is preferred as it shows low friction with the tubular mast elements 4, which are typically made of aluminum, preferably anodized aluminum, and which are inserted in the cylindrical opening 17 of the guide shaft 3 when the mast 2 is erected or retracted. The inventor thus came to the idea to use a tubular pipe 9 entirely made of a strong and low friction material as the core of the guide shaft 3. Other materials with low friction properties can also be used for the tubular pipe 9, for example: PTFE (Teflon), polyurethane (PUR), polyimide particularly nylon 6, nylon 66, nylon 11, nylon 12 or nylon 46 or copolymers thereof, polyester, in particular polyethylene-terephtalate (PET), polytrimethyleneterephtalate (PTT), polybutyleneterephtalate (PBT), high molecular weight polyethylene, ultra high molecular weight polyetheylene, polyetherketones, particularly polyethyletherketone (PEEK), PEEKK, polyethersulfones, polysylfones, polyvinylidenefluoride (PVDF), a polyester copolymer or mixtures of two or more of these polymers. A further advantage of these plastic materials is that they are electrically isolating, thereby electrically isolating the mast 2 and the equipment 8 mounted thereto from the legs 7 of the base 1, which is safer for the personnel erecting or retracting the mast 2, especially in case of a lightning strike. The base 1 of the present invention also works when the tubular pipe 9 is made of another material such as aluminum or an aluminum alloy, but the weight of such a base 1 using aluminum would be higher than a base 1 using POM, and there would be more friction with the tubular elements 4 of the antenna mast. Especially metal to metal contact should be avoided, as it causes scratches and wear to both surfaces of the metals in contact, which would obstruct smooth insertion and lifting or lowering of the mast elements 4 during erection or retraction of the mast, or would obstruct smooth rotation of the mast 2 when directing the equipment 8 mounted to the mast after erection. Especially for a mast 2 with heavy equipment 8 on top, e.g. an antenna or lighting of 25 kg or more, smooth movement and rotation of the tubular elements 4 in the tubular pipe 9 is important, and shocky movements should be avoided. Preferably the tubular pipe 9 has a shape with a radial symmetry, preferably with an inner and outer circular cross section, as such a shape can easily be produced or machined on a lathe, but the invention also works with other inner or outer shapes, e.g. square, hexagonal, octagonal.

In an alternative embodiment the collar 12 is made as a separate part, which is mounted upon the tubular pipe 9 using conventional fixation means, such as glue, screw-thread, etc. This approach allows a different material to be chosen for the collar 12 and for the tubular pipe 9, the latter being preferably made of POM. The collar 12 could e.g. be made of a material with a large load bearing capacity, for example a material with a hard surface that has only a limited risk to deformations when the mast suspending pin 36 (FIG. 4A) is resting upon it to support the full weight of the mast, e.g. steel or aluminum.

As shown in FIG. 1A and 1B, near the top of the tubular pipe 9 a first leg attachment collar 5 is mounted. FIG. 3B shows the first leg attachment collar 5 of the preferred embodiment of the present invention in more detail. It has a cylindrical opening 19 with an inner diameter larger than the outer diameter 52 of a lower part of the tubular pipe 9 to allow shifting the first leg attachment collar over the tubular pipe 9 during assembly, and a plurality of connection positions, e.g. three or more, whereto the legs 7 can be hingedly connected at a first connection position on the legs 37 using conventional connection means. The first leg attachment collar 5 can be made of the same material as the tubular pipe 9, or of a different material. The first leg attachment collar 5 is typically made of cast or machined aluminum or an aluminum alloy, as this is a strong and lightweight material that can easily be produced in the desired shape. The first leg attachment collar 5 needs to be strong to support the full weight of the mast during erection or retraction of the mast, and to transfer that weight to the legs 7 via the first connection position on the legs 37. Aluminum has a low mass density of approximately 2.7 kg/dm³, and the shape of this part is suited to be manufactured by casting or machining, which is an easy and economic process step. The height of the first leg attachment collar 68 is chosen such that tilting of the first leg attachment collar 5 is counteracted, e.g. when mounting it on the tubular pipe 9. In the preferred embodiment the height 68 is chosen approximately equal to the inner diameter of the first leg attachment collar opening 19, but other values are also possible. The person skilled in the art can use different sizes, shapes, materials and processes known in the art for making the first leg attachment collar 5.

In an alternative embodiment of the base 1 according to the present invention, the tubular pipe 9 and the first leg attachment collar 5 can be constructed as a single part, e.g. by injection molding, moulding or casting or extruding, and could be made of aluminum, an aluminum alloy or a plastic material as listed above.

As shown in FIG. 1A and 1B, the legs 7 can be connected to the base 1 using conventional connection means such as screws and bolts, or hinge pins 59 with a groove and circlipses mounted on both sides (as shown in FIG. 1C), but any other method known to the person skilled in the art can also be used. FIG. 1A shows a base 1 with three legs 7, but four or more legs are also possible.

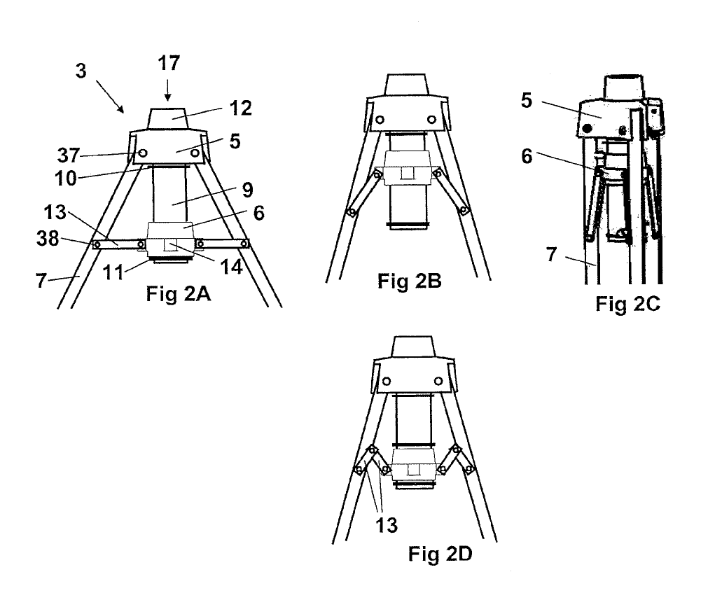

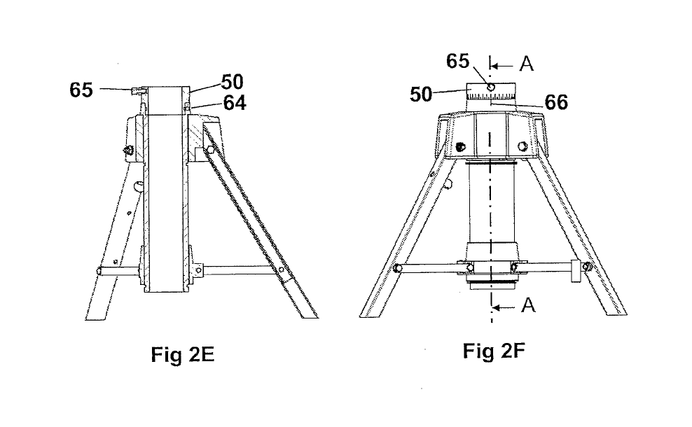

The tubular pipe 9 extends from the first leg attachment collar 5 to a position below the first leg attachment collar where preferably a leg guide collar 6 is mounted around the tubular pipe to enable a second connection between the legs 7 and the tubular pipe 9. FIG. 3C shows a preferred embodiment of the leg guide collar 6 of the present invention. The wall thickness of the leg guide collar 6 can be the same as that of the first leg attachment collar 5, or can be larger or smaller. Typically however the leg guide collar 6 can have a thinner wall thickness than that of the first leg attachment collar 5, as the leg guide collar 6 does not have to bear the full weight of the antenna mast 2, but only needs to hold the position of the legs 7, thus material cost and weight can be saved. The leg guide collar 6 is preferably made of machined aluminum or cast aluminum or another aluminum alloy that can be easily machined. By providing the leg guide collar 6 around the tubular pipe 9 instead of using a localized connection, the connection force can be divided over a large contact area. Preferably but not necessarily, the leg guide collar 6 is displaceable over the tubular pipe 9 in height direction of the mast 2 between an upper position limited by the position of the first leg attachment collar 5 and a lower position limited by second position limiting means such as e.g. a groove 16 and a circlips 11 mounted to a lower part of the tubular pipe 9. By shifting the leg guide collar 6 over the tubular pipe 9, the legs 7 are moved between an extended position, as shown in FIG. 2A, and a retracted position, as shown in FIG. 2C. It is clear that the open or extended position provides a stable base 1 for supporting a mast 2, while the closed or retracted position is used for easy transportation. This is especially useful for a temporary mast that needs to be set-up and retracted frequently. FIG. 2B shows an intermediate position, whereby the legs 7 are halfway between the extended and the retracted position. In an alternative embodiment of the present invention the leg guide collar 6 is rigidly mounted to the tubular pipe 9. In this case the connection between the legs 7 and the leg guide collar 6 preferably allows the distance between them to be adjustable, e.g. by using for each leg two guide spacers 13 hingedly connected in series, as shown in FIG. 2D. This enables the base 1 to be folded for transportation or unfolded for supporting a mast 2. In this case the legs 7 do not open or close simultaneously. The height of the leg guide collar 67 is preferably chosen such that the leg guide collar 6 cannot tilt, which would obstruct easy sliding over the tubular pipe 9. This height 67 can e.g. be chosen approximately equal to the inner diameter of the leg guide collar opening 21, but other values are also possible. The person skilled in the art can use different sizes, shapes, materials and processes known in the art. Preferably the leg guide collar 6 has a position for mounting an optional bubble level 14, to facilitate rapid installation of the base 1 in a vertical position. In an alternative embodiment of the guide shaft 3 the bubble level 14 could be mounted to the first leg attachment collar 5, or both. Instead of a single circular bubble level also two oblong bubble levels can be used.

At a second connection position on the legs 38, the legs 7 are connected to a lower part of the tubular pipe 9 using second connection means 39, which may be a direct connection or an indirect connection. In FIG. 1A showing the preferred embodiment of the base 1 of the present invention, the legs 7 are connected to the leg guide collar 6 using guide spacers 13 and conventional connection means. The guide spacers 13 are intended to keep the legs 7 of the base 1, when unfolded, at a predefined position from the tubular pipe to provide a stable base 1. They are typically made of steel or stainless steel, but they can also be made of a lightweight metal such as aluminum or an aluminum alloy, or other suitable materials known to the person skilled in the art.

The leg guide collar 6 is a preferred way of connecting the lower part of the tubular pipe 9 to the legs 7, but other ways are also possible, for example by mounting the guide spacers 13 to a protrusion (not shown) on the outer wall of the tubular pipe 9, or by using a tubular insert in the bottom of the tubular pipe 9, which insert can then be connected to the legs 7.

In a preferred embodiment the tubular pipe 9 has a tubular pipe collar 12 extending above the first leg attachment collar 5, to rest upon the first leg attachment collar 5 for transfer of the weight of the mast 2 during erection or retraction, and for temporarily supporting the mast suspending pin 36 (see FIG. 4A) which can be inserted in a mast element 4 during erection or retraction of the mast 2, as will be explained further. Other shapes of the tubular pipe collar 12 than the one shown in FIG. 1B can also be used.

Optionally but not mandatory the first leg attachment collar 5 and the leg guide collar 6 are mounted in a rotatable manner around the tubular pipe 9. In this case two levels of rotation can be provided to the mast 2 during set-up, as the tubular mast elements 4 can rotate inside the tubular pipe 9, and the tubular pipe 9 can rotate inside the first leg attachment collar 5 and inside the leg guide collar 6. This might be beneficial in environments where sand or dirt could hinder the rotation of the mast 2. This is particularly advantageous when directional antennas are mounted on the mast 2, as in this case the antenna should be correctly directed to within approximately one degree angle, thus smooth rotation of the mast inside the guide shaft 3 is desired. It will be described further, when discussing the field base 58, how rotation of the mast 2 can be prevented. In an alternative embodiment of the base 1 according to the present invention the first leg attachment collar 5 and the leg guide collar 6 can be mounted to the tubular pipe 9 in a non-rotatable way, using e.g. glue or screws, or grooves and a local insert, or any other technique known to the person skilled in the art to block such rotation.

Optionally but not mandatory the base 1 of the present invention has a graduated collar 50 which is mounted to the tubular pipe collar 12, and can be used for easy orientation and correct positioning of the mast 2, and optionally the collar 12 of the tubular pipe 9 has an indicator 66 that can be aligned with one of the graduations on the graduated collar 50. The graduated collar 50 shown in FIGS. 2E and 2F has the same inner diameter as the inner diameter of the tubular pipe 9, and has provisions with a groove and a first screw 64 to prevent the graduated collar 50 from being lifted along with the tubular mast elements 4 when erecting the mast 2. When the mast 2 is fully erected the graduated collar 50 can be mounted to a tubular mast element 4 by means of a second screw 65, so that the graduated collar 50 rotates along with the mast. Other shapes of the graduated collar, and other ways of mounting them known to the person skilled in the art, can also be used.

Choosing lightweight materials for the base 1 is especially advantageous for transportable masts 2, which need to be erected and retracted quite frequently.

FIGS. 4A-4E describe how the parts of FIGS. 3A-3E are mounted to form the preferred embodiment of the guide shaft 3 according to the present invention. Starting with a tubular pipe 9 (FIG. 4A), a first leg attachment collar 5 is shifted over the tubular pipe 9 until it reaches the tubular pipe collar 12 (FIG. 4B), where the outside diameter of the tubular pipe collar 12 is larger than the inner diameter of the first leg attachment collar opening 19. The tubular pipe collar 12 serves as the upper part of the first position limiting means 43. Next, a first circlips 10 (FIG. 3D) is mounted in the first groove 15 of the tubular pipe (FIG. 4C) to limit the lower position of the first leg attachment collar 5 on the tubular pipe 9, thus the height position of the first leg attachment collar 5 on the tubular pipe is fixed. In a next step the leg guide collar 6 is shifted over the tubular pipe 9 (FIG. 4D), and a second circlips 11 (FIG. 3E) is mounted in the second groove 16 of the tubular pipe 9 (FIG. 4E) to limit the lower position of the leg guide collar 6 on the tubular pipe 9. The second groove 16 and the second circlips 11 thereby form the second position limiting means 44. The resulting structure (FIG. 4E) is the preferred embodiment of the guide shaft 3 of the present invention. The leg guide collar 6 of the preferred embodiment of the guide shaft 3 can thus be shifted between the location of the first groove 15 and the second groove 16 on the tubular pipe. To make the base 1 of the present invention, legs 7 and second connection means, e.g. guide spacers 13, are attached to the guide shaft 3 using conventional attachment means such as screws and bolts, or hinge pins 59 with grooves and circlipses (FIG. 1C), but any other method known to the person skilled in the art can also be used.

The use of grooves 15, 16 in the tubular pipe 9 and circlipses 10, 11 mounted in the grooves is a very easy, fast and elegant way of limiting the positions, at only a minimal cost and labor during manufacturing. As there is never any substantial force exerted upon the circlipses 10, 11, the grooves 15, 16 can be made shallow, and the thickness W of the wall of the tubular pipe 9 can thus be substantially constant below the tubular pipe collar 12, as shown in FIG. 4A. When using POM as a material for the tubular pipe 9, the inventor has discovered that a wall thickness W of 5-15 mm, preferably 7-13 mm, more preferably 9-11 mm gives an optimal compromise in terms of weight and strength.

By choosing aluminum or an aluminum alloy or one of the plastic materials listed above for the parts of the guide shaft 3, it should be clear from the FIGS. 3A-3E and from the description that the parts of the guide shaft 3 of the present invention are lightweight and easy to manufacture. And it should also be clear from the FIGS. 4A-4E and from the description that the guide shaft 3 and the base 1 of the present invention can be easily assembled, thereby resulting in a lightweight, rigid and stable base 1 for a mast 2, showing low friction with the tubular mast elements 4, which are typically made of anodized aluminum.

In an alternative embodiment of the base 1 according to the present invention, the tubular pipe 9 and the first leg attachment collar 5 could be made as a single piece, or not. When using the same material for the tubular pipe 9 and for the leg guide collar 6, these parts can be made as a single piece, or not. When the first, second and third material are the same, the tubular pipe 9 and the first leg attachment collar 5 and the leg guide collar 6 can be made as a single piece, or not.

In an alternative embodiment of the base 1 according to the present invention, the tubular pipe 9 and the first leg attachment collar 5 and the leg guide collar 6 can be moulded or casted or extruded as a single part, resulting in a structure looking like the one shown in FIG. 4E without the grooves 15, 16 and circlipses 10, 11. This structure would not have the capability to move the leg guide collar 6 over the tubular pipe 9. However a base 1 using the guide shaft 3 of this alternative embodiment could also be folded and transported, e.g. after disconnecting the guide spacers 13 from the legs 7, or by using a series of guide spacers 13 as shown in FIG. 2D.

FIG. 4F shows an alternative embodiment of the tubular pipe 9 according to the present invention, where the outer diameter of the tubular pipe 9 is smaller at the position of the first leg attachment collar 5. In this case the first leg attachment collar 5 could be mounted by assembling two or more parts around the tubular pipe 9. In this way the first circlips 10 would not be required to limit the position of the first leg attachment collar 5.

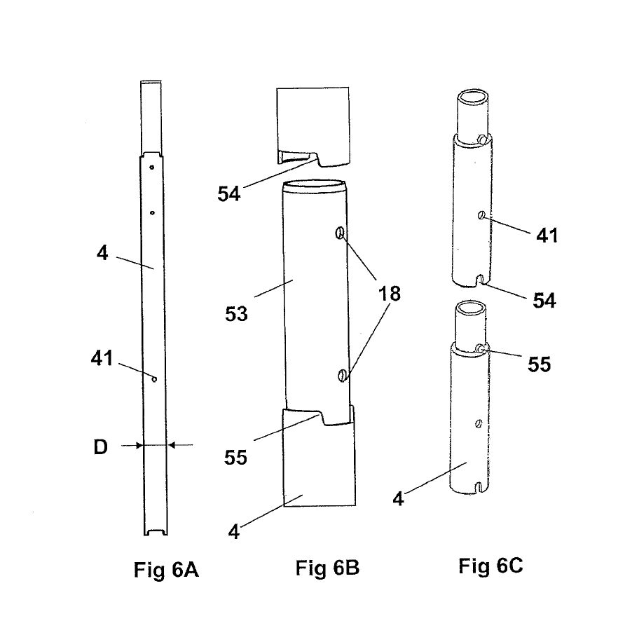

The principle of setting up a mast 2 using the preferred embodiment of the base 1 according to the present invention will be explained with reference to FIG. 5A. Starting from a folded base 1 as shown in FIG. 2C, first the legs 7 are opened, by shifting the leg guide collar 6 away from the first leg attachment collar 5 to obtain a stable base 1 as shown in FIG. 2A. Then the lengths of the legs 7 are adjusted to place the tubular guide shaft 3 at a height of e.g. 1.40 m above the ground to enable insertion of mast elements from a position below the guide shaft. The legs 7 of the base 1 are preferably made telescopic in conventional ways. In the example of FIG. 5A the length of the legs 7 can be adjusted using two leg adjustment screws 42 per leg, but any other means known to the person skilled in the art can also be used. Then the base 1 needs to be positioned vertically, which is typically done using the bubble-level 14 mounted to the leg guide collar 6 as an aid. The mast needs to be positioned as vertical as possible to prevent bending of the tubular mast elements 4, or falling over of the mast 2. Further a winch 20 and a lifting block assembly 23 can be attached to the base 1. Using the winch, the position of the lifting block assembly 23 is lowered to allow placement of a first tubular mast element 4 upon it. Then the first tubular mast element 4 is lifted using the winch and guided inside the upright opening 17 of the guide shaft 3 to a position extending above the tubular pipe collar 12. Next, one or more guy collar assemblies 25, 40 are shifted over the first tubular mast element 4 from above. In a next step a device 8, such as an antenna or camera or microphone or lighting etc. can be mounted to the first tubular mast element, using the device mounting holes 18 (FIG. 6B) and conventional attachment means e.g. screws. Optionally the legs 7 have provisions for mounting steps (not shown) thereto, which steps can e.g. be used to stand upon when mounting the equipment 8 to the mast 2. Then the first mast element 4 is further lifted until a mast suspending pin 36 can be inserted in a hole 41 (FIG. 4A, FIG. 6A) of the first tubular mast element 4, above the tubular pipe collar 12, where after the lifting block assembly 23 is lowered again so that the mast suspending pin 36 rests upon the tubular pipe collar 12, holding the first mast element 4 in a suspending position with respect to the guide shaft 3, as shown in FIG. 4A in dotted line. The lifting block assembly 23 can then be lowered further down, to enable placement of a second tubular mast element 4 upon it. Using the winch 20 the second tubular mast element 4 can then be lifted until its upper part approaches the lower part of the first tubular mast element 4 suspended in the base 1. The second tubular mast element 4 will then be aligned and rotated so that the upper part of the second tubular mast element 4 engages with the lower part of the first tubular mast element 4. Using the winch 20, both tubular mast elements 4 and the mounted equipment 8 are then lifted, the mast suspending pin 36 is removed, and the first guy collar assembly 25 is mounted to the upper tubular mast element 4 by inserting the guy collar assembly pin 34 in the hole 41 (FIG. 6A) of the upper tubular mast element 4. Then the partly mounted mast 2 is lifted further until the mast suspending pin 36 can be inserted in hole 41 of the second tubular mast element 4 above the tubular pipe 9, where after the lifting block assembly 23 is lowered again, and so on. When all tubular mast elements 4 are mounted, the position of the entire mast 2 including the lifting block assembly 23 is lowered so that a bottom element 24 (FIG. 5C) of the lifting block assembly 23 can be placed in a field base 58, which is mounted on the ground under the base 1 by means of spikes 78, so that the weight of the mast 2 no longer needs to be supported by the base 1, but is transferred directly to the field base 58.

It is an advantage of the guide shaft 3 of the present invention that it can be made of two or more components, preferably three (the tubular pipe 9, the first leg attachment collar 5, the leg guide collar 6), which are and remain well positioned with respect to each other during erection or retraction of a mast, and which provide an optimal guidance for the displacement of the tubular mast elements during erection or retraction of the mast 2.

FIG. 5A shows an antenna as the equipment 8 to be positioned at height, but other equipment such as e.g. a camera, a microphone or lighting can also be used.

FIG. 5A shows a mast 2 at an early stage of erection, with two guy collar assemblies 25, 40 shifted over the tubular mast elements 4 and temporarily resting on the tubular pipe collar 12, to enable mounting of the guy collar assemblies 25, 40 to specific tubular mast elements 4 during further erection of the mast 2, but more than two can also be used, e.g. for a large mast. By connecting the guy collar assemblies 25, 40 to specific tubular mast elements 4 during erection, they can be located at predefined positions T, M (FIG. 7A) after the mast 2 is fully erected. The guy collar assemblies 25, 40 allow stabilizing the mast 2 during erection, during retraction, and during normal use of the mast, i.e. when the mast is fully erected, by providing means for connecting at least three guy control wires 71 which can be kept under tension in at least three different directions, thereby keeping the mast 2 in a stable position.

FIG. 5B shows the preferred embodiment of the guy collar assembly 25, 40. It comprises a tubular element 26, whereto a blade 27 is preferably rotatably mounted. The blade 27 typically comprises at least three guy wire mounting holes 35 preferably equally distributed around the blade 27, but other positions are also possible. Referring to FIG. 7A, the wires, cables or ropes attached to the upper guy collar assembly 25 are called guy control wires 71, whereas the wires, cables or ropes attached to the other guy collar assembly (or assemblies) 40 are called guy wires 72. At least three guy control wires 71 are attached to the upper guy collar assembly 25 for keeping the mast 2 upright, each guy control wire preferably being mounted to one mounting hole 35. The first ends of the guy control wires 48 (FIG. 5D) are attached to the upper guy collar assembly 25, which is typically mounted to the upper tubular mast element 4 corresponding to a position T on the mast (FIG. 7A). The guy collar assembly 25 is preferably mounted to the mast using a removable connection, e.g. a removable pin 34 (FIG. 5B) passing through the guy collar assembly 25 and through a hole 41 of the tubular mast element 4, thereby fixing the position of the guy collar assembly 25 in height with respect to the mast 2. When using a mast 2 with two guy collar assemblies 25, 40, the second guy collar assembly 40 is typically mounted to the tubular mast element 4 corresponding to a position M at about half the height of the mast 2 (FIG. 7A). When three guy collar assemblies 25, 40 are mounted to the mast, they are preferably placed near the top, near ⅔ of the height, and near ⅓ of the height of mast, etc. In an alternative embodiment of the present invention the guy collar assemblies 25, 40 can have four or more guy wire mounting holes 35, for attachment of four or more guy (control) wires 71, 72.

In the prior art, the second ends of the guy control wires 71 are typically routed to three different positions X, Y, Z near the ground, located at a predetermined distance R from the base 1, thus lying on an imaginary circle with the base 1 standing in the centre, the three positions X, Y, Z lying preferably 120 degrees apart on the imaginary circle. In the prior art these guy control wires 71 are only fastened to the positions near the ground after the mast 2 is fully erected, not during erection or retraction of the mast. Alternatively they are kept under tension by three or more persons standing at a distance R from the base 1 during erection of the mast, and they are fastened to a position near the ground after the mast is fully erected. In other words, in the prior art the guy control wires 71 are typically routed from point T to X, from T to Y and from T to Z, and they are fastened at the points X, Y, Z to a position near the ground after the mast is fully erected. A disadvantage of the first mentioned prior art method is that the mast is not stabilized during erection or retraction, making it impossible or unsafe to set-up a mast under windy conditions. A disadvantage of the second mentioned method used in the prior art is that it requires more people during the set-up of the mast, and that it is very difficult to keep the mast stabilized when the three or more guy control wires are held by three or more different people, without causing oscillations of the mast 2. These disadvantages are especially important in military applications, where the minimal amount of personnel, optimal safety to the equipment 8 on and next to the mast 2, as well as a fast set-up time under all weather conditions are of main importance.

The present invention provides an improved method for keeping the mast 2 upright, during normal use of the mast, as well as during its erection or retraction, even under windy conditions, with a minimal amount of people, using mechanical means that can be hand carried, and without requiring electrical power or batteries. This is especially important for military applications. Thereto the present invention uses a method of routing the guy control wires 71 to a single point P, where a single person can keep the three or more guy control wires 71 under tension, by using a guy control assembly 28. The guy control assembly is also an object of the present invention.

In order to be able to apply this improved method for stabilizing the mast 2 during erection or retraction, the mast assembly 47 comprises at least three guy control wires 71, the first ends 48 of the guy control wires 71 being connected to the mast 2 at an upper position T on the mast 2, the second ends 49 of the guy control wires 71 being routed to at least three different positions X, Y, Z near the ground at a distance from the base 1, to which positions they can be fastened, which is typically done after the mast 2 is fully erected, or from which positions they can be routed further to a single position P to permit keeping the guy control wires 71 under tension by a single person during erection or retraction of the mast.

Preferably the three different positions X, Y, Z near the ground are located on an imaginary circle of radius R, lying preferably 120 degrees apart, where the base 1 is standing in the centre, and the radius R is chosen such that the angle β between the ground surface and the guy control wire 71 is between 45 and 60 degrees, preferably 55 degrees. Using these positions provides for a uniform tension in the guy control wires 71 and optimal correction capabilities for the mast 2.

As shown in FIG. 7B, preferably the locations X, Y, Z near the ground each comprise a pully block 56 to allow further routing of the guy control wires 71 to a point P where a single person can keep the guy control wires 71 under tension during erection or retraction of the mast 2, and a guy tensioner 32 to allow fastening the guy control wires 71 to the position near the ground after erection of the mast 2. Instead of continuously adapting the length or position of each of the guy control wires 71 during the erection or retraction of the mast 2, the person at point P can move between a first point P1 and a second point Pn, thereby adapting the length of all guy control wires 71 simultaneously, while keeping them under tension. The point P1 preferably being located on an imaginary line passing through the center of the base 1, at a predetermined distance from the center of the base of typically 1.3-1.5 times the height of the mast, and the point Pn being located on the same line at a distance of typically 0.8-1.0 times the height of the mast, the exact distance depending on the angle β between the ground surface and the guy control wires 71.

Preferably this method is performed by routing the second ends 49 of the guy control wires 71 to a guy control assembly 28 located at location P, the guy control assembly 28 having means for keeping at least three guy control wires 71 under tension. The guy control assembly 28 is a tool that can be hand held, and allows to keep all guy control wires 71 under tension simultaneously. It also allows the tension of one or more guy control wires 71 to be adapted while keeping the other guy control wires under tension.

Preferably the guy control assembly 28 has at least three wire holding means 31 for holding the guy control wires 71 under tension, and has at least two handles 75, 76 for holding the guy control assembly 28, the handles being located at opposite sides of the part guiding the wires.

Preferably the guy control assembly 28 has three handles 75, 76, 77 by which it can be held, one on the left, one on the right, and one below.

Preferably the wire holding means 31 are rope cleats.

As shown in FIGS. 7A-7D, the three guy control wires 71 of the present invention have an increased length, typically almost double the length typically used in the prior art, and they are routed from T over X to Y to P₁, from T over Z to Y to P₁ and from T to Y to P₁, the three guy control wires 71 thus coming together at a single point Y, from where they are routed to a point P₁ where a single person holding the guy control assembly 28 can keep the three guy control wires 71 under tension simultaneously, especially during erection or retraction of the mast 2. Typically the person holding the guy control assembly 28 starts at a position P₁ at the start of the mast erection and gradually approaches to a point Pₙ while the mast elements 4 are being lifted, in order to keep the guy control wires 71 under tension. When the mast 2 is completely erected, the guy control wires 71 are fastened to the support surface, e.g. the ground, by means of fastening means. Preferably the guy control wires 71 are fastened to pickets 30 at location X and Z and to a control picket 29 at location Y, by means of e.g. guy tensioners 32, pulley blocks 56 and carbine hooks 33. After all the guy control wires 71 are fastened to the pickets 30 and to the control picket 29, the other guy wires 72, which are fastened at one end to the guy collar assembly 40 which is mounted to the mast, are also tightened and fastened to the pickets 30 or to the control picket 29. Thus after the mast 2 is fully erected, each guy control wire 71 and each guy wire 72 is fastened at one end to the mast, preferably to a guy collar assembly 25, 40, and to a position on the control surface, preferably a picket or control picket, at the other end, thereby keeping the mast in a fixed position.

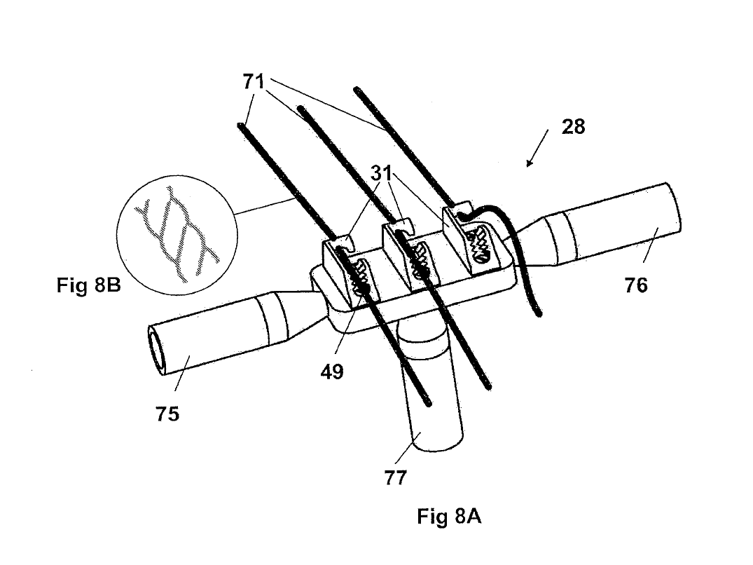

FIG. 8A shows a preferred embodiment of the guy control assembly 28 of the present invention in more detail. It comprises three handles, a left handle 75, a right handle 76 and a lower handle 77, and three rope cleats 31 for attaching the second ends 49 of the guy control wires 71 to the guy control assembly 28. The three guy control wires 71 are placed on the rope cleats 31 and are kept under tension such that the mast 2 is standing upright. The person holding the guy control assembly 28 typically uses both hands holding the left and right handle 75, 76 to have good control over the guy control assembly 28. By moving towards or away from the base 1, the guy control wires 71 are kept under tension, and the mast 2 is kept upright. When a single guy control wire 71 needs to be adjusted, a right handed person typically releases his left hand to grasp the lower handle 77, and then releases the right hand to correct the position of the guy control wire 71 while firmly holding the guy control assembly 28 in his left hand and keeping the other guy control wires 71 under tension. After correction of the specific guy control wire 71 he takes again the right handle 76 in the right hand, and finally also the left handle 75 in the left hand.

Alternatively first the right hand can be moved to the bottom handle, and then the left hand released to correct the position of a wire, etc.

When retracting a mast, a similar procedure as described above for erecting a mast 2 can be followed, but the person holding the guy control assembly 28 would start from a point Pₙ near the point Y on the imaginary circle, and gradually move away from the base 1 towards a point P₁, while keeping the guy control wires 71 under tension.

An alternative embodiment of the guy control assembly 28 may comprise one or two handles, and/or four or more rope cleats 31. Other shapes of the guy control assembly 28, or of the handles 75-77, or of the rope cleats 31 than shown in FIG. 8A are possible.

FIG. 8B shows an example of a guy control wire 71, which is preferably made of Terylene ™, polyester or Kevlar®, but other materials are also possible. The guy control wires 71 should be strong enough to support the tension exerted upon it, especially under windy conditions.

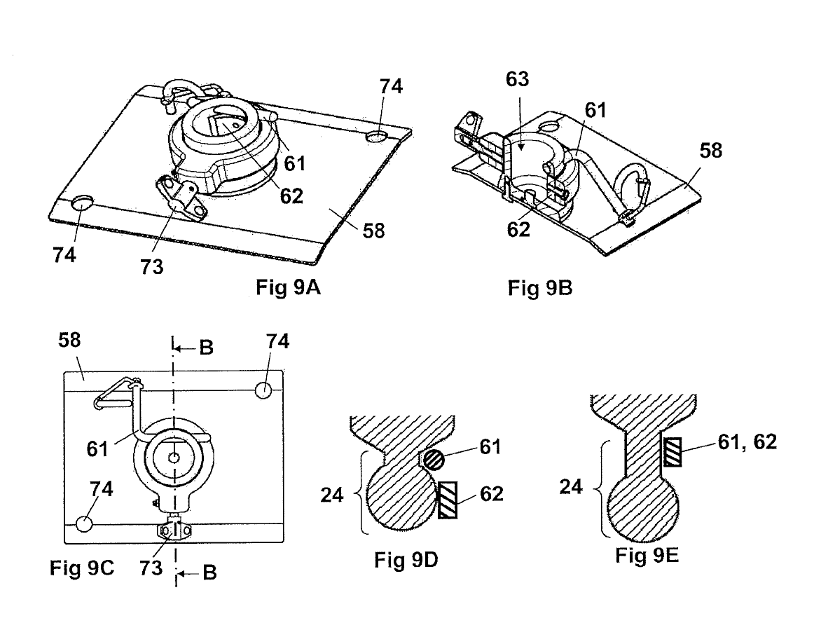

The present invention also provides an improved field base 58 for supporting the mast during its normal use, i.e. when fully erected. The field base 58 is provided for positioning on a supporting surface, e.g. on the ground, at a position which corresponds to the position of the mast 2 to permit bearing of at least part of the weight of the mast 2 after erection, whereby the field base 58 comprises first fixation means 61 for fixing the mast 2 to a support plane and preventing displacement in height direction of the mast assembly 47, and second fixation means 62 for preventing rotation of the mast 2 around its axial axis. FIGS. 9A-9C show a preferred embodiment of the field base 58 according to the present invention. The field base 58 has an opening 63 extending in upright direction of the mast for receiving a bottom element 24 which is preferably mounted to a lower part of the mast 2 in a non-rotatable way. The bottom element 24 may have constant dimensions in radial direction, but preferably has a smaller outer dimension at a higher part than at a lower part. The field base 58 has provisions for receiving first fixation means 61, e.g. a pin, which can be inserted in a second opening of the field base 58 to decrease the size of the upright opening 63, thereby preventing the mast 2 to move in an upward direction. The field base 58 further comprises a fixation component 62 mounted to the field base 58. The fixation component 62 can be moved towards (or away from) the center of the upright opening 63 in radial direction for tightening (or loosening) the bottom element 24 to (or from) the field base, thereby preventing (or allowing) rotation of the mast 2.

FIG. 5A shows a field base 58 mounted to the ground in a position corresponding to and below the mast 2. The field base 58 is typically mounted to the ground by inserting spikes 78 in the ground through the mounting holes 74 of the field base 58, so that the field base 58 cannot rotate or be lifted with respect to the ground. Positioning the mast 2 on the field base 58 is the last step during erection of the mast 2. After all tubular elements 4 have been added to the mast 2 as described above, the mast 2 with the lifting block assembly 23 mounted underneath, is lowered towards the support surface, usually the ground, so that the lower part of the lifting block assembly 24, in this case a sphere with a small cylindrical shape on top of it, is placed inside the upright opening 63 of the field base 58. Then a height fixation pin 61 of the field base is inserted in a second opening of the field base 58 to decrease the inner diameter of the upright opening 63. The pin 61 prevents displacement of the bottom element 24 in height direction of the mast 2, which could occur under windy conditions, whereby the mast 2 could be lifted out of the field base 58, and be positioned next to the field base 58, thereby loosing its vertical position and/or its orientation. Insertion or removal of the height fixation pin 61 is a very fast and simple step for securing or releasing the height position of the mast 2.

FIG. 9A and 9C show a wing screw 73 to enable tightening of a fixation component 62 against the bottom element 24 of the mast 2, thereby preventing rotation of the mast 2. FIG. 9D shows the working principle using a separate first and second fixation means 61, 62. FIG. 9E shows the working principle of an alternative embodiment of the field base 58 according to the present invention, using a single fixation means 61, 62 to prevent both lifting and rotation of the mast 2 with respect to the field base 58. An advantage of using a spherical shape as the bottom element 24 of the lifting block assembly 23 is that it does not have sharp edges, thereby preventing injuries during the set-up of the mast 2, and it allows easy rotation of the mast 2 when positioned in the field base 58, and it is easy to manufacture e.g. on a lathe. But the invention also works for other bottom elements 24 having a lower diameter at a higher position than at a lower position. Providing the fixation component 62 as a separate part allows the shape and material thereof to be optimized for optimal tightening to avoid rotation of the mast 2.

In a preferred embodiment of the invention the bottom element 24 and the fixation component 62 are both made of aluminum. To have a large contact area with the bottom element 24 and thus a good fixation, the shape of the fixation component 62 is preferably complementary to at least part of the bottom element 24. Other shapes and materials for the bottom element 24 and for the fixation component 62 can be chosen by the person skilled in the art, e.g. the sphere of the bottom element 24 could be replaced by a cylinder made out of steel.

FIGS. 6A-6C show examples of tubular mast elements 4 known in the art, comprising means for preventing disengagement of successive mast elements 4. To allow an easy, well aligned placement of the mast elements 4 on top of each other, and to prevent the mast elements 4 from disengaging, typically a cylindrical insert 53 with an outer diameter approximately equal to the inner diameter of the tubular mast elements 4 is mounted in the upper end of each tubular element 4, and extending above it, to enable insertion thereof in the lower end of the next higher tubular mast element 4 in the mast 2. Usually device mounting holes 18 are foreseen in this cylindrical insert 53, which device mounting holes 18 can be used for fixation of the equipment 8 such as e.g. an antenna, lighting, camera, microphone etc, using standard fixation means such as e.g. screws. The lower end of the tubular mast elements 54, and the higher end of the tubular mast element 55 typically have a complementary form to prevent rotation between a lower and the next higher mast element 4. As the tubular mast elements 4 can rotate inside the tubular pipe 9 of the base of the invention, and as all mast element 4 of the mast 2 cannot rotate with respect to each other, it is possible to orient the equipment 8 mounted on the mast 2 by rotating any of the mast elements 4, thereby rotating the entire mast 2. The outer diameter D of the tubular mast elements 4 typically lies between 50 and 110 mm, and can for example be 110 mm, 100 mm, 90 mm, 80 mm, 70 mm, 60 mm or 50 mm. The length of the tubular mast elements 4 without taking into account the cylindrical insert 53 is typically 1 m, which makes it easy to transport them, to insert the tubular mast elements 4 from a position below the guide shaft 3, and to determine the height of an erected mast 2 by simply counting the superimposed mast elements 4. But the tubular mast elements 4 can also have other lengths, such as e.g. 80 cm, 90 cm, 100 cm, 110 cm or 120 cm.

1-13. (canceled)

14: A mast assembly (47) comprising a base (1) and a transportable mast (2), the mast (2) comprising a plurality of tubular mast elements (4) positioned on top of each other, the base (1) comprising:
a guide shaft (3) comprising a tubular pipe (9) having an opening (17) for guiding the displacement of the tubular mast elements (4) during erection or retraction of the mast (2);
a plurality of legs (7) connectible to the guide shaft (3), for positioning the guide shaft (3) at a distance above ground to allow insertion of the tubular mast elements (4) from a position below the guide shaft (3);
a first leg attachment collar (5) mounted to an upper part of the tubular pipe (9), the first leg attachment collar (5) being connectible to the legs (7) at a first connection position on the legs (37);
second connection means (39) provided at a lower part of the guide shaft (3), which second connection means (39) are connectible to the legs (7) at a second connection position on the legs (38), the second connection position (38) being spaced from the first connection position (37) in height direction of the base (1);
wherein:
the tubular pipe (9) is a single piece extending from above the first leg attachment collar (5) to a position below the first leg attachment collar (5) where the second connection means (39) are provided; and
the second connection means (39) comprise a leg guide collar (6), which extends around the lower part of the tubular pipe (9) and is spaced apart from the first leg attachment collar (5) in height direction of the base (1).

15: The mast assembly (47) according to claim 14, wherein the tubular pipe (9) has a tubular pipe collar (12) extending above the first leg attachment collar (5) adapted for resting upon the first leg attachment collar (5) for transfer of the weight of the mast (2) during erection or retraction thereof, where an outside diameter of the tubular pipe collar (12) is larger than an inner diameter of an opening (19) of the first leg attachment collar (5).

16: The mast assembly (47) according to claim 14, wherein the tubular pipe (9) is made of a first material selected for easy sliding of the mast elements (4) therein, and the first leg attachment collar (5) is made of a second material for providing a strong and stable base (1) which is capable of temporarily bearing the full weight of the mast (2) during its erection or retraction, and transferring it to the legs (7).

17: The mast assembly (47) according claim 14, wherein the leg guide collar (6) is movable in a direction along a longitudinal axis of the tubular pipe (9), and is connected to the legs (7) via guide spacers (13) to permit movement of the legs (7) of the base (1) between an extended position in which they stably support the base (1) and a retracted position for easy transportation.

18: The mast assembly (47) according to claim 14, wherein the leg guide collar (6) is made of a third material.

19: The mast assembly (47) according to claim 18, wherein the first, second and third material have a mass density between 1.0 and 3.0 kg/dm³.

20: The mast assembly (47) according to claim 18, wherein the first, second and third material is chosen from the group of aluminum, an alloy of aluminum with another metal, a plastic material selected from the group of polyoxymethyleen (POM), PTFE (Teflon), polyurethane (PUR), polyimide particularly nylon 6, nylon 66, nylon 11, nylon 12 or nylon 46 or copolymers thereof, polyester, in particular polyethylene-terephtalate (PET), polytrimethyleneterephtalate (PTT), polybutyleneterephtalate (PBT), high molecular weight polyethylene, ultra high molecular weight polyetheylene, polyetherketones, particularly polyethyletherketone (PEEK), PEEKK, polyethersulfones, polysylfones, polyvinylidenefluoride (PVDF), a polyester copolymer or mixtures of two or more of these polymers.

21: The mast assembly (47) according to claim 18, wherein the first material is a plastic material, preferably POM and the second and third material are aluminum or an aluminum alloy.

22: The mast assembly (47) according to claim 14, wherein the tubular pipe (9) has a circular cross section with a constant outer diameter (52) over at least part of its height in axial direction, to allow movement of the leg guide collar (6) along an outer wall of the tubular pipe (9), and in that the tubular pipe (9) comprises first position limiting means (43) on the upper part of the tubular pipe (9) with the purpose of limiting movement of the first leg attachment collar (5) along the tubular pipe (9) in axial direction.

23. The mast assembly (47) according to claim 14, wherein the tubular pipe (9) comprises second position limiting means (44) on the lower part of the tubular pipe (9) to limit movement of the leg guide collar (6) in downward direction, the second position limiting means (44) being spaced apart from the first position limiting means (43) to permit movement of the leg guide collar (6) between them.

24: The mast assembly (47) according to claim 14, further comprising at least one guy control assembly (28) for stabilizing the mast (2) during erection or retraction of the mast (2), the guy control assembly (28) being connected to the mast (2) at a predefined position (T) in at least three directions by means of at least three guy control wires (71), a first end of each guy control wire (48) being connected to the mast (2), a second end of each guy control wire (49) being connected to the guy control assembly (28), each guy control wire (71) being guided at a position between the first and second end of the guy control wire (71) towards a ground position (X, Y, Z) located at a distance (R) from the base (1), to which positions they can be fastened or from which positions they can be routed further to a single position (P) to permit keeping the guy control wires (71) under tension by a single person.

25: The mast assembly (47) according to claim 14, wherein the mast assembly (47) further comprises a field base (58) for supporting the mast (2), which field base (58) is provided for positioning on the ground or any other suitable support at a position which corresponds to the position of the mast (2) to permit bearing of at least part of the weight of the mast (2) after erection, whereby the field base (58) comprises first fixation means (61) for fixing the mast (2) to a support plane and preventing displacement in height direction of the mast assembly (47), and second fixation means (62) for preventing rotation of the mast (2) around its axial axis.

26: The mast assembly (47) according to claim 25, wherein the field base (58) has an upright opening (63) for receiving a bottom element (24) mounted to the mast (2) in a non-rotatable way, the bottom element (24) having a smaller outer diameter at a higher part than at a lower part, and in that the first fixation means is a pin (61) which can be inserted in an upper part of the field base (58) to decrease the size of its upright opening (63), and in that the second fixation means (62) comprises a fixation component (62) mounted to the field base (58), which fixation component (62) can be moved towards or away from the center of its upright opening (63) in radial direction for tightening or loosening the bottom element (24) to or from the field base (58), thereby preventing or allowing rotation of the mast (2).
